(19) United States
(12) Patent Application Publication
(10) Pub. No.: US 2014/0249979 A1
(43) Pub. Date: Sep. 4, 2014

(54) ENHANCING THE HANDLING SPEED OF ELECTRONIC FINANCIAL SERVICES MESSAGES

(71) Applicant: SECODIX CORPORATION, Vancouver (CA)

(72) Inventors: Damir Wallener, Duncan (CA); Lewis Johnson, Delta (CA); Brendan Tonner, Vancouver (CA); Ken Unger, Surrey (CA)

(73) Assignee: SECODIX CORPORATION, Vancouver (CA)

(21) Appl. No.: 13/782,854

(22) Filed: Mar. 1, 2013

(51) Int. Cl. G06Q 40/00

(52) U.S. Cl. CPC G06Q 40/04
USPC 705/37

(57) ABSTRACT

Handling is expedited for electronic financial service messages, particularly those destined for an exchange 60 or other trading venue. Messages are parsed into two informational components, with the first component requiring computations that must happen extremely fast and the second component requiring state updates, for example, that can happen on a longer timeframe. Real-time balancing of optimizing throughput versus optimizing latency is achieved for financial message handling. The system allows for the automatic switching between the two methods of optimization based on either user controlled or independently controlled message rate thresholds.

### FIELD OF THE INVENTION

The present invention relates to the ordering and handling of electronic financial services messages destined for an exchange or other trading venue.

### BACKGROUND

Ever since the Rothschilds allegedly used carrier pigeons to trade on the outcome of the Battle of Waterloo, there has been a drive to increase the speed of one's financial trades to gain a competitive edge in the financial services industry. Until high speed servers came into existence in the late 20^{th} century, orders were transmitted over the telephone and received over a telegraphic stock ticker. Now, high speed servers transmit electronic orders both wirelessly and over fibre-optic cables near the speed of light, with servers being physically located as near to financial exchanges as possible in order to decrease the time delay, or latency, between an order's transmission and execution.

Efforts to improve the speed at which a trade occurs have also focused on optimizing network system designs. Currently, speeds can be increased through real-time latency monitoring and ensuring that trading traffic is always on a path with minimum latency, for latency optimized systems. Systems can also be designed to optimize throughput, however present art systems are fixed at design time to be either latency optimized or throughput optimized with respect to message handling and can not automatically switch between the two. For a given processing power, a specific message in a latency optimized system will take less time to process, but a lower rate of messages can be handled when compared to a throughput optimized system, where a specific message will take longer to pass through but more messages can be handled. Current typical real world latencies are on the order of 20-100 microseconds; however some consider anything over 5 microseconds to be too long.

It would be useful to further enhance the speed at which time critical events, such as trades, occur by providing a system and method for improving the speed with which individual electronic messages are handled.

It would also be useful to obtain the benefits of both throughput-optimized and latency-optimized systems.

This background information is provided to reveal information believed by the applicant to be of possible relevance to the present invention. No admission is intended, nor should be construed, that any of the preceding information constitutes prior art against the present invention.

### SUMMARY OF THE INVENTION

The present invention provides a system that employs several processes for enhancing the handling speed of electronic financial services messages coming into and out of a financial service provider so that messages are handled as efficiently as possible.

A fast-path slow-path risk checker process is employed on incoming messages to a financial services center. Messages containing orders intended for an exchange or other trading venue, including commodities, currency, derivative, fixed income, and stock exchanges pass through a financial services data center and are handled on a fast-path basis while those messages coming into the financial services center such as updates from an exchange or updates going out to a trader occur on a slower path.

The speed at which incoming messages containing fast-path designated orders are handled is further enhanced by a message parsing process which parses individual incoming messages in a manner that extracts information needed for time critical computations from state update information that can be handled on a longer timeframe.

The system also employs a dual process for optimizing in real-time the balancing of throughput versus latency for electronic message handling. The system allows for the automatic switching between the two optimized pathways based on either user defined or independently defined preferences.

In accordance with the present invention, electronic financial services messages, such as order entry messages destined for an exchange or other trading venue, are handled in a manner that separates time-critical information that requires computations that must happen extremely fast from state updates that can happen on a longer timeframe.

Further in accordance with the present invention, a system and method are disclosed for analyzing the extracted time-critical information in order to optimize the real time information traffic flow and automatically switch on the fly between a throughput-optimized and a latency-optimized system for electronic message handling.

Still further in accordance with the present invention, a system and method are disclosed for optimizing real-time balancing of throughput versus latency of traffic flow for electronic message handling based on either user controlled or independently controlled settings and preferences.

Disclosed are one or more non-transitory computer readable media comprising computer readable instructions which, when processed by one or more processors cause said processors to: receive a financial service message comprising first data and second data; parse the message to extract the first data; check the first data against one or more parameters in a memory; transmit the first data along a first path to an exchange if the check is successful; and transmit the second data to the memory along a second path slower than the first path.

Also disclosed is a system for processing financial service messages comprising: a memory and one or more processors connected thereto, the processors configured to: receive a financial service message comprising first data and second data; parse the message to extract the first data; check the first data against one or more parameters in the memory; transmit the first data along a first path to an exchange if the check is successful; and transmit the second data to the memory along a second path slower than the first path.

Further disclosed is a method for processing financial service messages comprising the steps of: receiving, by a processor, a financial service message comprising first data and second data; parsing, by the processor, the message to extract the first data; checking, by the processor, the first data against one or more parameters in a memory; transmitting, by the processor, the first data along a first path to an exchange if the check is successful; and transmitting, by the processor, the second data to the memory along a second path slower than the first path.

These and other features and advantages of the invention will be apparent from the following detailed description and a review of the associated drawings. It is to be understood that both the foregoing summary and the following detailed description are explanatory only and should not be construed as restricting the scope of the invention as claimed.

### BRIEF DESCRIPTION OF THE DRAWINGS

FIG. 1 illustrates an electronic message flow diagram showing the fast and slow paths taken by messages coming into and out of a financial services' data center from traders and exchanges.

FIG. 2 illustrates a flow diagram showing the parsing of incoming electronic messages and the directional flow of the parsed data through a financial services' communication and data process server(s).

FIG. 3 illustrates a logic flow diagram for the processing of and selective message paths for incoming messages.

FIG. 4 illustrates a logic flow diagram for the method of switching between low traffic optimized and high traffic optimized message processing paths.

FIG. 5 illustrates an example networked environment showing how a financial services center employing the invention is connected within a network to other entities, stakeholders and network components.

### DETAILED DESCRIPTION OF THE INVENTION

It is desirable to reduce the time it takes in handling individual messages coming in from traders, including any necessary pre-trade risk checks. The electronic messages coming in can be in any electronic message format. The Financial Information eXchange (FIX) Protocol format which is an industry standard protocol is often used by many traders and a number of exchanges. However the invention is applicable to any electronic message protocol format used by traders, applications and exchanges including but not limited to Extensible Markup Language (XML), Financial Information eXchange Markup Language (FIXML), OUCH, POUCH and RASHport protocol standards.

The core content of an incoming message includes information such as Account, (who is placing the trade); Price (the price at which the trade is being made); Symbol (the “name” of the asset being traded); and Size (the number of shares to be traded).

Risk checks are performed to measure the “riskiness” of a message just received; and as these checks must be performed, they are often perceived as a regulatory “time tax”. To minimize the impact of these regulatory computations, it is already accepted practice to treat the computational results as approximations, rather than precise answers. This allows the process to ignore the asynchronous nature of a communication between, for example, a trader and an exchange. The specific implementation for this is a risk check gateway, which must accept or reject messages based on their content, and relative to state information derived from previous messages.

Examples of some computations that must happen extremely fast include such housekeeping chores as looking up the symbol to see if it is a tradable object, as well as looking up the account to see if it is authorized to trade. Determination of authorization to trade may include such things as whether or not the order is too large (Size>some threshold); and whether or not the value of the order is too large (Size*Price>some threshold). Authorization to trade may also include whether the particular account is making too many trades (Sum of all Size*Price for that account>some threshold) or trading too fast (Number of Orders in specified timeframe>some threshold).

The state update portions of an incoming message are those updates that do not have a time critical component to them. Some examples of state updates that do not need to occur as quickly include things like adding an incoming trade to the list of previous trades, and updating the current value of all trades for the account with the value of the incoming trade. Other state updates may include updating the “timing” information to keep track of how fast orders are coming in.

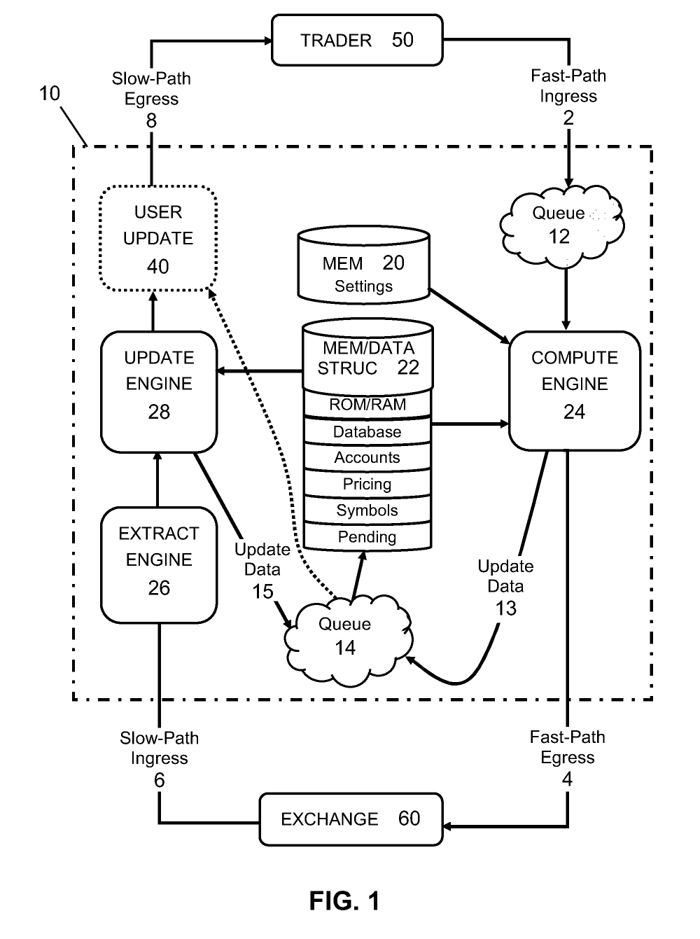

As illustrated in FIG. 1, messages come into a Financial Message Processor (FMP) 10 from two directions. Messages coming into the fast ingress path 2 of the FMP 10 from a trader 50 destined for an exchange 60 are considered “fast-path” messages and handling of these messages needs to occur quickly; while those coming into the slow ingress path 6 of the FMP 10 from an exchange 60, back to a trader 50 on slow egress path 8, are considered “slow-path” messages and can be handled over a longer period of time. The fast path can be considered to be along the fast-path ingress 2, through the queue 12, the compute engine 24 and the fast-path egress 4. The slow path can be considered to be any or all paths connected to slow-path queue 14.

At an exchange 60, generally incoming trade requests are queued up in the order they arrive. So the quicker messages can pass through FMP 10 the sooner they can get into the queue at an exchange 60. In addition, when a sequence of orders is being sent, the quicker they can be processed, the more likely they will arrive at the exchange 60 as a block of messages without any interspersed orders from competitors.

Messages coming in from a trader 50 are “requests” on an exchange 60. Messages coming from an exchange 60 are responses to the request. Two distinct data paths exist in the FMP 10, one for messages originating from a trader 50, and the other for messages originating from an exchange 60. There exists shared memory and data structures 22 between the two data paths. This shared memory and the data structures 22 hold data that is stored in a known way; for example as files, databases and directories. The shared memory and data structures 22 are embodied in one or more memories and are accessible to both paths. The shared memory and data structures 22 are read-only to messages coming in from a trader 50, and read-write for messages coming in from an exchange 60.

The shared memory and data structures 22 record and store information related to the current state and history of each account. For example, an individual “account” record within the structure would store information such as a list of all outstanding trades executed since the account was started; a list of all executed trades since the account was started; the value of all executed and/or outstanding trades, arranged by symbol; and an aggregate value of all trading, summed across all traded symbols for that account.

Each account record has components which are updated from an incoming trade request message and are of the “outstanding trade” category. Account record components updated from messages coming from an exchange 60 are both of the “outstanding” variety (for example, a request to delete/undo an outstanding trade after a trade is accepted, representing a confirmation to execute it) or of the “executed” variety (values are moved from an outstanding state to an executed state once confirmation that a trade has actually taken place is received from an exchange 60, the trade having been fulfilled in part or in full).

The fast-path and slow-path have independent message queues. The fast-path message queue 12 allows the fast-path to function as fast as possible during periods of high message traffic. The slow-path queue 14 can buffer its own messages and process them over an extended period of time. The fast-path queue 12 has one input and is located directly between the fast-path message ingress 2 to the FMP 10 and the compute engine 24. The slow-path queue 14 has two inputs, these being update data 13 (of the “outstanding” variety) from an incoming trade as the message is being processed by the compute engine 24 and update data 15 (of the “outstanding” and “executed” variety) incoming from an exchange 60.

As illustrated in FIG. 1, a message incoming from a trader 50 comes into the FMP 10 along a “fast-path” message ingress 2. It is accepted as input and placed in a fast-path queue 12. The message is then parsed by the compute engine 24 and data is extracted from the message content including items such as the Account ID, Symbol, Size of order, and Price. The message is then classified as to type. For example, the message can be classified as an order request or as a cancellation of an earlier order. Based on the classification of the message, the compute engine 24 extracts specific information from a local shared memory containing data structures 22 where individual account information is stored and accessed. Some information stored in the state/history data structures may be information that can provide answers to questions such as “what is the value of all current holdings attached to this account?”, “how many different assets is this account holding?”, “how many different assets is this account allowed to hold?”, “does this account have any outstanding orders still unprocessed by the exchange?”

A second local memory store 20 contains independent and/or user defined preferences and settings which can be in the form of configuration, limit and/or threshold settings which can be set by an independent application or user. These settings are stored in a separate data structure, second local memory store 20, which is separate from the earlier referenced shared memory and data structures 22.

The compute engine 24 then combines the information from the message with the information from the shared memory and data structures 22 and second local memory store 20. If the result of the computation is acceptable, the necessary portion of the message is immediately forwarded out of the FMP 10 along fast-path message egress 4 to an exchange 60 server where the request is executed. Note that the form of the message may change as computation checks are performed and the trade request message is converted into an order sent on to the exchange.

There are two steps to determining if the result of a computation is acceptable and therefore able to be immediately forwarded out to an exchange 60. The first step is a set of checks which are selected from an available pool of checks; the default being that all checks are active. This first step is generally an activity performed at the start-up of a user's trading account, although the checks can also be actively managed in near real time. The incoming message must pass all of the checks. If the incoming message fails any activated check, the message is not forwarded to the exchange. In the case of an unforwarded message, a notification may be sent to the shared memory and data structures 22 storing the data of the user's account and then notification may also be sent to trader 50 along slow-path message egress 8 as a user update 40.

The compute engine 24 may also update the local shared memory and data structures 22 by enqueueing update data 13 to queue 14 along the slow-path. Generally this type of data would be Account ID, Symbol, Size of order, and Price information extracted from the incoming message; along with some calculated values, such as “Value=Size*Price” computed by the fast-path.

Also shown in FIG. 1 is a “slow-path” message ingress 6 which manages messages coming into the FMP 10 from an exchange 60. Messages from the exchange 60 are parsed, and information is extracted by the extract engine 26 as necessary. Extracted information from an exchange 60 may include some or all of the following: a) a unique identifier to identify which order request is being responded to, and b) the status of that specific trade request (i.e. rejected, accepted, executed).

An update engine 28 combines the extracted information from the message coming in from the exchange 60 with information in the local shared memory and data structures 22, and then updates the shared memory and data structures 22 based on the result. These updates are shown in FIG. 1 as update data 15 and are placed into slow path queue 14. Information in the slow path queue 14, or buffer, is used to update the local shared memory and data structures 22 without interfering with fast-path message egress 4.

As described earlier, examples of such an update may include the status of the trade (i.e. whether the trade was rejected, accepted, executed) and the update engine 28 will update the status of an order such as “total value executed” and “total value outstanding”. In the case of a successful trade execution, the “total value executed” would be increased and the “total value outstanding” would be decreased by the same amount. If the trade was executed in its entirety, the specific data structure holding the “outstanding” value or record can then be optionally deleted, as it is no longer needed; or it can just be updated showing the trade being executed in its entirety.

It may be noted that two closely-spaced messages from a trader 50 could result in the second message clearing the fast-path before the slow-path can update the account status. However this is considered an acceptable practice, as the checks are in a category of “close enough” and the second message may be processed before a response from the first message is received from the exchange 60.

Another aspect of the invention to improve the speed with which electronic financial services messages are handled is through the real-time balancing of electronic message flow in a way that optimizes latency and throughput based on the traffic flow. Because FIX messages are an industry standard protocol and often used by many traders 50 and a number of exchanges 60, the invention is described in greater detail with reference to the handling of this type of electronic message. However the system is applicable to any electronic message protocol format used by traders, applications and exchanges including but not limited to Extensible Markup Language (XML), Financial Information eXchange Markup Language (FIXML), OUCH, POUCH and RASHport protocol standards. A translator engine can be employed for translating electronic messages coming into the FMP 10 in one order protocol format that need to egress to an application, exchange 60 or trader 50 in another protocol format.

Within the system design of the invention, there is a real-time balancing of FIX (or other preferred protocol format) message flow that optimizes latency and throughput based on the traffic flow into the system. Switching between a latency optimized flow and a throughput optimized flow can occur automatically and independent of user control, or if desired, can occur taking into account user preferences and settings.

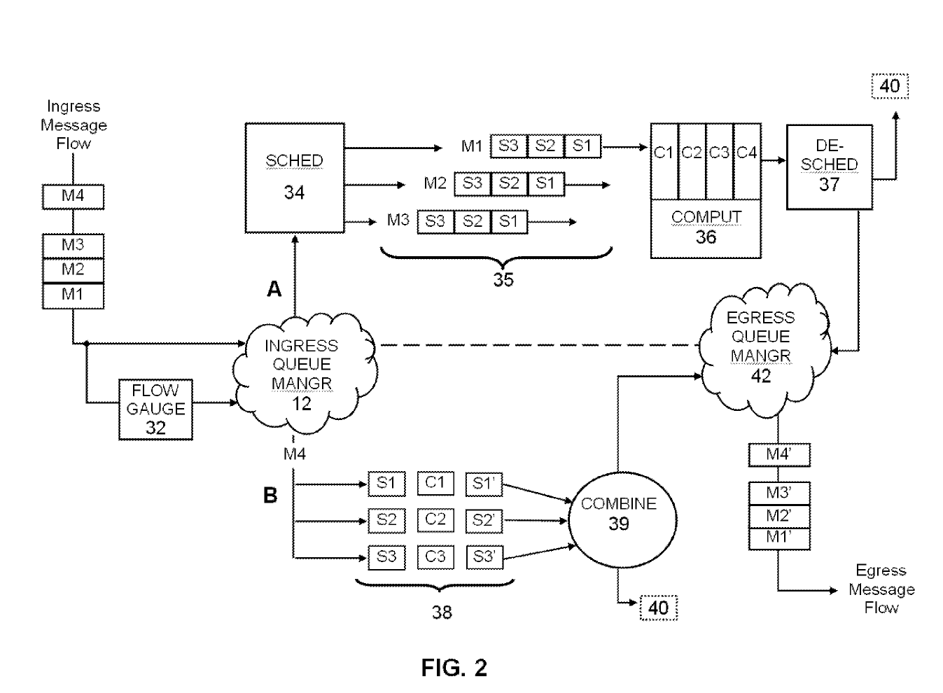

A primary criteria for switching between the two optimization methods is the order rate. For example, if messages are arriving faster than X/millisecond, the system uses a throughput-optimized configuration shown as processing Path “A” along the top half of FIG. 2. When the message rate drops below this threshold, the system switches to a latency-optimized configuration shown as processing Path “B” along the bottom half of FIG. 2.

As shown in FIG. 2, the system is designed having two distinct data paths, one is highly parallel and optimized for latency (Path B); while the other is pipelined and optimized for throughput (Path A). The system includes a means of measuring traffic flow, shown as flow gauge 32. The measured traffic flow includes measuring the packet flow, message flow and instantaneous bandwidth usage. The system includes a method of determining which data path to take and a method of switching data paths without hindering computational flow. Furthermore, the system provides a means of ensuring data coherency during a switch-over. Such means is a pause in the output of messages from the ingress queue manager 12 until all computations in the preceding alternate path have occurred and arrived in the egress queue manager 42.

Each message must undergo a series of calculations, based on the content of the message. The end result of the calculations results in two transformations; 1) a signal notifying the user or downstream process of the result and 2) modification of the message content based on the computational result.

As shown in FIG. 2, there are two paths to processing a message. Path “A” is a throughput or pipeline design where no particular message is handled very fast, but many messages can be handled at the same time. The computational process 36 is broken down into several independent stages. A message passes through the stages sequentially. As it leaves an earlier stage, the next message can enter that stage, even though the first message has not completed all stages. In principle, then, if you have N stages, there could be N messages undergoing various parts of the computation, all at the same time. The computational steps (C1, C2, C3, C4 and so on) can be organized as a series of independent processors each performing a computational step, or as separate threads on an individual processor, or a combination of several threads on several processors, allowing for very high throughput. Where a processor is referred to it may be a single processor or multiple processors, and a processor may have multiple processing cores.

Messages are denoted in FIG. 2 in the order they come into the system as M1, M2, M3, and M4 respectively; with M1 denoting a message that comes in before M2 and so on. Messages come into the ingress queue manager 12 and during high traffic flow are directed to the scheduler 34, which then directs each message down a pipeline. Path A may be made up of one or more pipelines 35; with three being shown in FIG. 2. A pipeline or multiple pipeline approach is a better design for when the number of messages flowing through the system is so large that the messages begin to backlog. Under this operating condition, the best approach is to process messages as they come in, in sequence, but using multiple parallel paths or pipelines 35. Any given message will take longer to process due to its passing sequentially through steps C1-C4, but the overall flow through the process allows for a minimum of backlog, so the net result is that the messages are collectively processed more quickly, with higher throughput.

Parsing of the individual messages occurs independent of the processing path before entering the ingress queue manager 12. In the case of a multi-pipeline design as illustrated in FIG. 2, a scheduler 34 implements a method, such as round robin, for choosing which pipeline a message should go down. The 3 pipelines shown in FIG. 2 are staggered to show message M1 exiting the scheduler first and being sent down the top pipeline for computational processing 36 before M2 and then M3. The blocks S1, S2, S3 denote message data segments extracted from the original incoming message (M1, M2, M3). Each parsed message proceeds through a computational process 36 where computational steps or checks (denoted C1, C2, C3, C4 in FIG. 2) are performed. The descheduler 37 is essentially a queuing mechanism to make sure that the results are sent to the egress queue manager 42 in the correct order. A user notification or update 40 can be sent out along a slow-path once the descheduler 37 has queued the message for egress to the designated exchange 60.

The second path to processing a message, as shown in FIG. 2, is through Path “B” which is a latency optimized approach that uses a parallelizer. Only one message can be handled at any given moment, which reduces throughput, but all computations on the data segments of that message are performed in parallel. Message M4 is shown being directed down Path “B” with message data segments (S1, S2, S3) extracted from the original incoming message M4 being processed in parallel (see 38 in FIG. 2) by individual, componentizable computational checks (denoted C1, C2, C3) allowing the result for that particular message to be known sooner than if the segments were processed sequentially. Note that calculation checks C1-C3 are the same for both Path A and Path B. The resulting processed message data segments, denoted S1′, S2′ and S3′ after having gone through the computational checks, are then sent to combiner 39 which combines the segments into message M4′ and sends the results to the egress queue manager 42. Depending on implementation choice, one message can be undergoing calculation (in parallelizer 38) while the preceding message is being combined (in combiner 39), or a message may not start the next compute cycle until after the combining of the preceding message is complete. User notifications or updates 40 can be sent out along a slow-path once the combiner 39 has queued the messages (denoted M1′-M3′ after processing the checks) for egress to the designated exchange 60.

In an alternate embodiment, a split step can be implemented to split the calculations (C1, C2, C3) into separate paths so that one message can be being split while the preceding message is undergoing calculation. However depending on the hardware used, splitting the individual messages can introduce a touch more latency than treating it as a monolithic block.

When traffic builds up in the parallel approach of Path B, even though any given message is processed very quickly, the fact that it has to sit in a queue waiting its turn for processing means that the message is not, in fact, handled in a “timely manner”. The key is to implement both approaches. A traffic flow “gauge” 32 measures traffic flow (by any number of suitable methods known in the art), and based on that flow, the ingress queue manager 12 decides which approach (or process) should be utilized. The ingress queue manager 12 also has methods for ensuring that switchover between the two processes occurs without loss of messages, and without re-ordering of messages at the output end.

To prevent re-ordering, the input or ingress queue manager 12 is organized on a first-in first-out (FIFO) basis, so messages are guaranteed to be pulled from the queue in the correct order. When a switchover condition is encountered, it will momentarily stop pulling messages from the queue until it has received a signal that the current path has finished processing messages already in flight.

In a system utilizing the dual processes as described, typical processing time differentials between parallel processed messages compared to pipeline or serially processed messages may range from approximately 4× to 8× faster for the parallel processed messages being handled. For example, there may be a 1 microsecond duration required for the parallel processing of a message during low traffic flow, versus a 4 microsecond duration required when pipeline processing the message during high traffic flow. Of course the speeds can vary depending on exactly what computations are needing to be done. So long as there is a significant difference in the processing times between the two paths, then the system is generally worth implementing. A minimum difference may, for example only, be a factor of about three between the speeds of each path.

The goal is to have “zero latency” during normal traffic, and “really low” latency during heavy traffic. For the current state of the art, really low latency would be anything under 3-4 microseconds and may also be referred to as “ultra low latency”.

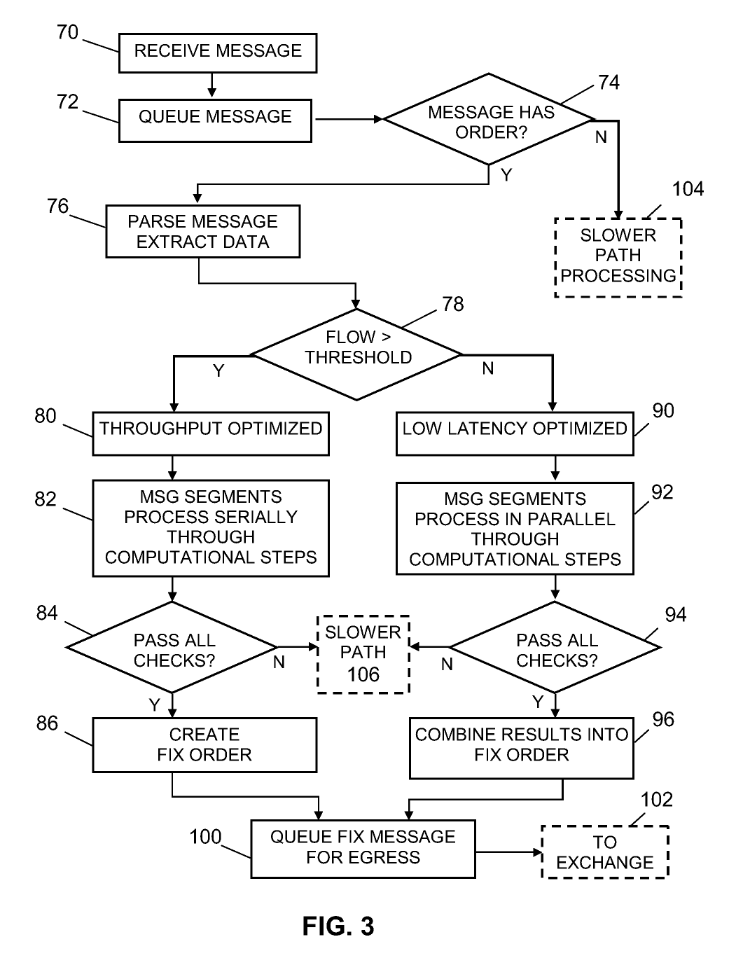

A logic flow diagram for the processing and selecting of message paths for incoming messages is illustrated in FIG. 3. The process begins with the receipt of an electronic financial message (step 70) which is queued (step 72). The message content is determined in step 74 and if it contains time-critical components it is directed to fast-path ingress queue manager 12; otherwise it is directed to a slower processing path (step 104). The message is then parsed and the time critical components are extracted in step 76. If the incoming message traffic flow is determined to be greater than a specified threshold (step 78) then the message segments (time critical components) are sent sequentially to step 80 which is a throughput optimized process path (Path “A”). If the incoming message traffic flow is less than a specified threshold (step 78) then the message segments are sent to step 90 which is a low latency optimized process path (Path “B”).

Once the message segments are directed to step 80, for throughput optimized processing, the message segments are directed down a pipeline processing path where they are processed serially through computational checks (“C1”, “C2”, “C3”, “C4”) in step 82. If the message segments pass all active computational checks at step 84 then the message becomes an order (step 86) in descheduler 37 and is forwarded onto an egress queue manager 42 (step 100) which forwards the order on to a designated exchange (step 102). If the message segments do not pass all active computational checks at step 84 then the message is kicked out of line and sent down a slower processing path (step 106).

Going back to step 78 in FIG. 3, if the incoming message traffic flow is less than a specified threshold then the message segments are sent to step 90 which is a low latency optimized processing path (Path “B”). The message segments go through all active computational checks (“C1”, “C2”, “C3”, “C4”) in parallel (at the same time) at step 92 and if they pass all active computational checks at step 94 then the resulting message segments are combined (step 96) into an order message and sent on to egress queue manager 42 (step 100) which forwards the order on to a designated exchange 60 (step 102). If the message segments do not pass all active computational checks at step 94 then the message is kicked out of line and sent down a slower processing path (step 106).

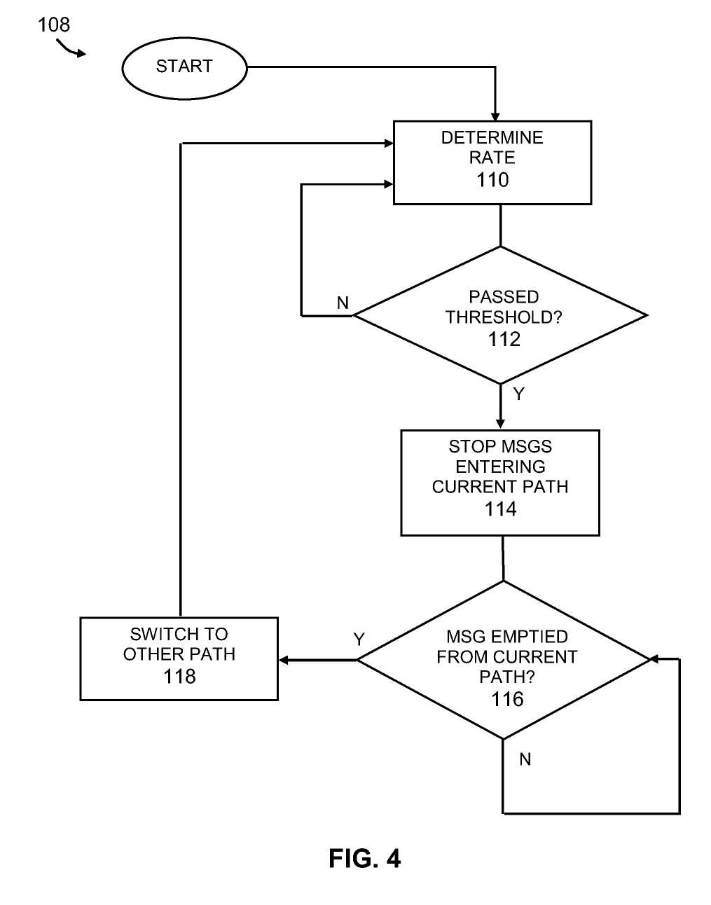

FIG. 4 shows a logic flow diagram for the process, 108 of switching between low traffic optimized and high traffic optimized message processing paths. To prevent re-ordering, the input or ingress queue manager 12 is organized on a first-in first-out (FIFO) basis, so messages are guaranteed to be pulled from the queue in the correct order. The logic diagram starts with the traffic flow ingress rate being determined, step 110. If the rate has not passed a defined threshold, step 112, then the method of processing incoming messages remains the same, and the rate is determined (step 110) again in a continual loop until the rate passes the defined threshold (step 112), when a switchover condition is encountered. When a switchover condition is encountered, the queue manager 12 will momentarily stop messages entering the current processing path (step 114) and will stop pulling messages from the queue until it has received a signal that the current path has finished processing messages already in flight, in step 116. Once the current path has finished processing messages and is clear, the processing path switches to the other path (step 118), and messages are once again output from the ingress queue manager 12. The traffic flow ingress rate again is determined, in step 110 and repeatedly so, until the next time the threshold is passed, in step 112. Note that one threshold may be set for changing from latency optimized to throughput optimized and a different threshold be set for changing from throughput optimized to latency optimized. This will build in some hysteresis in order to prevent the system from too rapidly switching back and forth between the two paths.

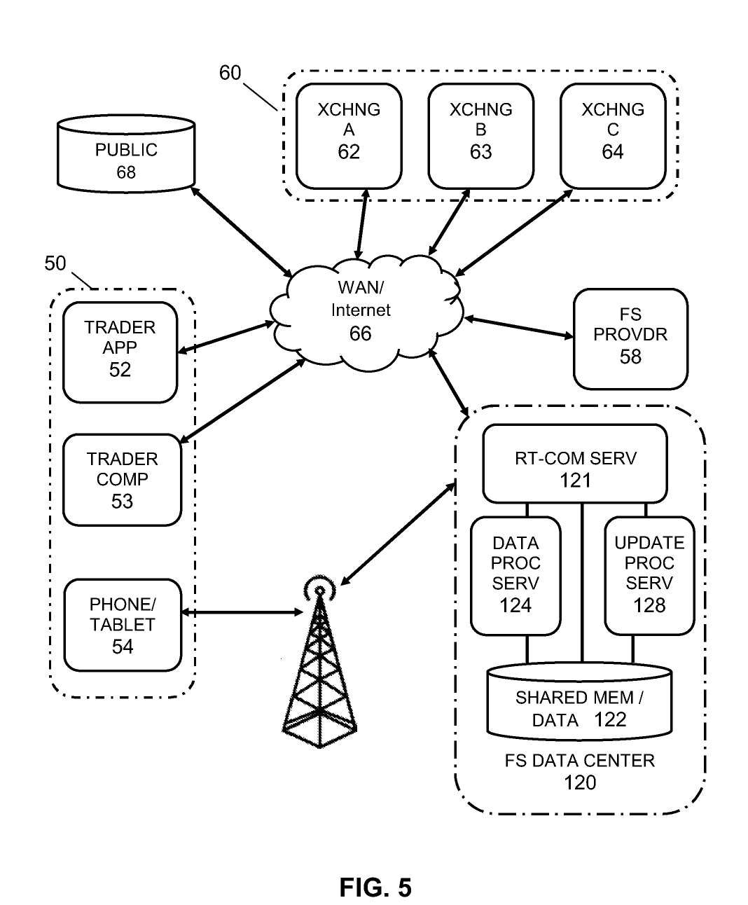

An example of a networked environment is illustrated in FIG. 5, with a financial services center 120 employing the inventive system. The financial services center 120 is connected within a network to other entities, stakeholders and network components. Messages generally come in from a network connection from a remote application to a financial services center 120. Messages coming in from the internet or other wide area network (WAN) 66 may include messages from a trader application 52, trader computing device 53, or a cellular or other wireless network from for instance a trader's phone/tablet 54. Messages may also come in from one of a number of exchanges which are represented in FIG. 5 as Exchange A (62), Exchange B (63) and Exchange C (64). The financial services data center 120 may also be connected to applications of financial service providers 58 (either within the financial service providers network or 3^{rd} party financial service providers) and connected to external data storage including historical data that may be found in public data storage 68. Other wireless networks contemplated but not shown include satellite based networks and those based on microwave transmission technology, such as one used by Tradeworx. It is also possible for an application generating the messages to exist on the same hardware, in which case the sending application would queue messages into a buffer and the receiving application would pull messages from the buffer.

The financial services data center 120 illustrated in FIG. 5, includes separate connected hardware. A real time communications server 121, or other component designed for the efficient handling of incoming and outgoing messages, is connected to data processing components, such as data processing server 124 and update processing server 128. The communications component may also be connected to shared memory and database component 122 and/or may access separate memory and data storage components (internal and external to data center 120). The data processing server 124 may function as the fast-path compute engine 24 earlier described and illustrated in FIG. 1 for quickly processing incoming messages containing orders such as a trade order. The update processing server 128 may function as the slow-path update engine 28 earlier described and illustrated in FIG. 1. Both the data process server 124 and update process server 128 are connected to a shared memory and database component 122, which may contain the memory and data structures 22 and second local memory store 20 earlier described and illustrated in FIG. 1. For an application of the inventive system wherein incoming messages may be in one order protocol format but needing to egress to an application, exchange 60 or trader 50 in another protocol format, a translation processor may be employed within for instance, the real time communications server 121, for translating electronic messages coming into the data center before forwarding on to either a queue manager for fast-path data processing of for instance, an incoming order, or to a buffer for slow-path update processing.

It is understood by one skilled in the art that the communication functionality may also be part of the same hardware as the data processing and update processing functionality of the system, and the memory and data storage may be separate compartmentalized areas of a single shared component or separate networked components (internal and external to) data center 120.

It should also be noted that specific timescales given herein are only guidelines. What are now considered particular working timescales will likely fall in the future as technology improves. However, it is expected that the system will still be able to provide the benefit of optimizing latency or throughput depending on the incoming message rate.

The foregoing embodiments of the invention are examples and can be varied in many ways. Such present or future variations are not to be regarded as a departure from the scope of the invention, and all such modifications as are obvious to one skilled in the art are intended to be included within the scope of the following claims.

We claim:

1. One or more non-transitory computer readable media comprising computer readable instructions which, when processed by one or more processors cause said processors to:
receive a financial service message comprising first data and second data;
parse the message to extract the first data;
check the first data against one or more parameters in a memory;
transmit the first data along a first path to an exchange if the check is successful; and
transmit the second data to the memory along a second path slower than the first path.

2. The computer readable media of claim 1, further configured to cause said processors to:
receive a response message from the exchange along a third path slower than the first path;
extract third data from the response message; and
update, along the second path, the second data in the memory with the third data.

3. The computer readable media of claim 2, further configured to cause said processors to:
send a message to a trader based on the third data, along a fourth path slower than the first path.

4. The computer readable media of claim 1, wherein the second path comprises a queue.

5. The computer readable media of claim 1, wherein the first data is extracted and checked in priority to said transmission of the second data.

6. The computer readable media of claim 1, further configured to cause said processors to:
extract the first data as segments;
determine whether to check the segments sequentially or in parallel; and
depending on said determination either check each segment sequentially or check the segments in parallel.

7. The computer readable media of claim 6, further configured to cause said processors to:
measure a rate at which said processors receive financial service messages;
compare the rate to a threshold;
check the segments sequentially if the rate is above the threshold; and
check the segments in parallel if the rate is below the threshold.

8. A system for processing financial service messages comprising:
a memory; and
one or more processors connected thereto, configured to:
receive a financial service message comprising first data and second data;
parse the message to extract the first data;
check the first data against one or more parameters in the memory;
transmit the first data along a first path to an exchange if the check is successful; and
transmit the second data to the memory along a second path slower than the first path.

9. The system of claim 8, said processors further configured to:
receive a response message from the exchange along a third path;
extract third data from the response message; and
update, along the second path, the second data in the memory with the third data.

10. The system of claim 9, said processors further configured to:
send a message to a trader based on the third data, along a fourth path slower than the first path.

11. The system of claim 8, wherein the second path comprises a queue.

12. The system of claim 8, wherein the first data is extracted and checked in priority to said transmission of the second data.

13. The system of claim 8, the processors further configured to:
extract the first data as segments;
determine whether to check the segments sequentially or in parallel; and
depending on said determination either check each segment sequentially or check the segments in parallel.

14. The system of claim 13, the processors further configured to:
measure a rate at which said processors receive financial service messages;
compare the rate to a threshold;
check the segments sequentially if the rate is above the threshold; and
check the segments in parallel if the rate is below the threshold.

15. The system of claim 13, the processors further configured to:
repeatedly measure a rate at which said processors receive financial service messages;
repeatedly compare the rate to a threshold;
while the rate stays on a same side of the threshold, check the segments of first data of a succession of financial service messages in one way selected from sequentially or in parallel; and
when the rate passes the threshold, check the segments of first data of subsequent financial service messages in another way selected from sequentially or in parallel.

16. The system of claim 15, the processors further configured to:
complete said checking in said one way before starting said checking in the other way.

17. A method for processing financial service messages comprising the steps of:
receiving, by a processor, a financial service message comprising first data and second data;
parsing, by the processor, the message to extract the first data;
checking, by the processor, the first data against one or more parameters in a memory;
transmitting, by the processor, the first data along a first path to an exchange if the check is successful; and
transmitting, by the processor, the second data to the memory along a second path slower than the first path.

18. The method of claim 17, further comprising the steps of:
receiving, by the processor, a response message from the exchange along a third path;
extracting, by the processor, third data from the response message; and
updating, by the third processor and along the second path, the second data in the memory with the third data.
sending, by the processor, a message to a trader based on the third data along a fourth path slower than the first path.

19. The method of claim 17, wherein the first data comprises one or more of a trade symbol, a price and an order size.

20. The method of claim 17, further comprising the steps of:
extracting the first data as segments;
measuring a rate at which the processor receives financial service messages;
comparing the rate to a threshold;
checking the segments sequentially if the rate is above the threshold; and
checking the segments in parallel if the rate is below the threshold.
